(19) United States
(12) Patent Application Publication
(10) Pub. No.: US 2025/0318550 A1
(43) Pub. Date: Oct. 16, 2025

(54) PRODUCTION METHOD OF PROCESSED SOY MILK FOOD

(71) Applicant: NIPPON CORPORATION, Tokyo (JP)

(72) Inventors: Yosuke KURASAWA, Atsugi-shi, Kanagawa (JP); Yuki SATO, Atsugi-shi, Kanagawa (JP); Chie SEKIGUCHI, Atsugi-shi, Kanagawa (JP); Eriko AOKI, Atsugi-shi, Kanagawa (JP); Kosuke TAKAHASHI, Atsugi-shi, Kanagawa (JP)

(73) Assignee: NIPPON CORPORATION, Tokyo (JP)

(21) Appl. No.: 18/865,401

(22) PCT Filed: May 17, 2023
(86) PCT No.: PCT/JP2023/018425

§ 371 Date: Nov. 13, 2024

(30) Foreign Application Priority Data
May 18, 2022 (JP) 2022-081321

(51) Int. Cl. A23J 3/22; A23B 2/80; A23B 11/29; A23C 11/10; A23L 5/10

(52) U.S. Cl. CPC A23J 3/227; A23B 2/80; A23B 11/293; A23C 11/103; A23L 5/10

(57) ABSTRACT

A solution to address the problem of providing a processed soy milk food that has a good meltability in mouth without any roughness or coarseness and an elastic texture similar to a processed and cooked meat product and that maintains the good texture even after freezing and thawing is disclosed. This problem is solved by using a coagulant in addition to a coagulated product of soy milk and a protein material.

### TECHNICAL FIELD

This invention relates to a method of producing processed soy milk food.

### BACKGROUND ART

In recent years, health problems caused by excessive intake of animal fat contained in meat have been reported. As the number of people who prefer plant-based foods for health reasons increases, the market for meat-like foods using plant-based protein materials is expanding, and there is a demand for meat-like foods with a texture closer to that of meat.

Conventional meat-like foods include granular products (such as granular soy protein) that are made by heating and pressurizing a raw material containing plant-based protein materials derived from soybeans or wheat using an extruder or similar device, thereby causing them to expand. These are all distributed and sold as dried products, and need to be rehydrated before use. In addition, they have a strong odor peculiar to plant-based protein materials, the inner layer is porous, the texture is spongy and gummy, and the texture becomes soft due to water absorption during rehydration.

To solve these problems, a method of producing meat-like food using soybean curd (so-called tofu) and a protein material (Patent Literature 1) and a method of producing processed meat-like food using the meat-like food (Patent Literature 2) have been proposed. However, there has been a problem that the texture tends to become dry and crumbly after freezing and thawing.

### CITATION LIST

### Patent Literatures

Patent Literature 1: Japanese Patent Application Publication No. 2020-28246
Patent Literature 2: Japanese Patent Application Publication No. 2021-129527

### SUMMARY OF INVENTION

### Problems to be Solved by the Invention

An object of the present invention is to provide processed soy milk food having a good mouthfeel without dryness or roughness, a texture with elasticity like cooked processed meat products, and further having a good texture even after freezing and thawing.

### Means for Solution of the Problems

The present inventor has found that by using a coagulant in addition to soy milk coagulum and a protein material, a food texture similar to that of cooked processed meat products can be obtained, and a good texture can be maintained even after freezing and thawing, thereby completing the present invention.

That is, the present invention includes the following aspects.
[1] A method of producing processed soy milk food, comprising the following steps 1 to 3 and satisfying conditions 1 and 2
   step 1: a step of preparing a soy milk coagulum,
   step 2: a step of mixing the soy milk coagulum, a coagulant, and a protein material to obtain a raw material mixture, where
   condition 1: the amount of protein derived from the protein material is 9.5 to 34% by mass relative to the total amount of the raw material mixture, and
   condition 2: the amount of solid content derived from the soy milk coagulum is 2.5 to 30% by mass relative to the total amount of the raw material mixture, and
   step 3: a step of heating the raw material mixture.
[2] The method of producing processed soy milk food according to [1], wherein the amount of the coagulant used in step 2 is 0.3 to 10 parts by mass relative to 100 parts by mass of the protein derived from the protein material.
[3] The method of producing processed soy milk food according to [1] or [2], wherein the protein material is selected from the group consisting of soy protein isolate, pea protein, chickpea protein, mung bean protein, broad bean protein, wheat protein, and egg protein. [4] The method of producing processed soy milk food according to any one of [1] to [3], further comprising a step of freezing the heated raw material mixture after step 3.

### Advantageous Effects of Invention

According to the present invention, it is possible to obtain processed soy milk food having a good mouthfeel without dryness or roughness, and a texture with elasticity like cooked processed meat products. Furthermore, it is possible to obtain processed soy milk food having a good texture even after freezing and thawing.

### DESCRIPTION OF EMBODIMENTS

The present invention relates to a method of producing processed soy milk food, comprising the following steps 1 to 3 and satisfying conditions 1 and 2
step 1: a step of preparing a soy milk coagulum,
step 2: a step of mixing the soy milk coagulum, a coagulant, and a protein material to obtain a raw material mixture, where
condition 1: the amount of protein derived from the protein material is 9.5 to 34% by mass relative to the total amount of the raw material mixture, and
condition 2: the amount of solid content derived from the soy milk coagulum is 2.5 to 30% by mass relative to the total amount of the raw material mixture, and step 3: a step of heating the raw material mixture.

### (1) Step 1: A Step of Preparing a Soy Milk Coagulum

In the present invention, “soy milk coagulum” refers to a product obtained by adding a coagulant to soy milk, which is obtained by swelling and grinding soybean grits, heating the resulting slurry, and squeezing it, so that the soy milk coagulates. Generally, such soy milk coagulum includes commercially available products such as regular tofu, soft regular tofu, silken tofu, packed silken tofu, silken tofu curds, unpressed tofu (yose tofu), and firm tofu (kata tofu). Regular tofu is tofu made by adding a coagulant to soy milk, pouring the resulting coagulum into a mold with holes lined with cloth, and pressing and shaping it. Silken tofu is tofu made by coagulating thicker soy milk than that used for regular tofu with a coagulant, pouring the mixture into a mold to solidify, and soaking it in water. Packed tofu is tofu made by adding a coagulant to thick soy milk used for silken tofu after cooling, filling it into a rectangular container made of synthetic resin, heating it at about 90° C. for 40 to 50 minutes to shape it, and then cooling it. In the present invention, the term “soy milk coagulum” is not limited to solid form and includes, for example, a paste form. From the viewpoint of production efficiency, it is preferable to use regular tofu.

Step 1 may include a step of adjusting the solid content (water content) of the soy milk coagulum. The method of adjusting the solid content of the soy milk coagulum is not particularly limited, and examples thereof include a method of adjusting the solid content by applying pressure to the soy milk coagulum to dehydrate it; a method of obtaining soy milk coagulum by solidifying soy milk whose water content has been adjusted in advance with a coagulant; and a method of adding water to a paste obtained by grinding soy milk coagulum. More specifically, according to the method of producing regular tofu, the solid content of the soy milk coagulum can be adjusted by dehydrating the coagulum obtained by adding a coagulant to soy milk by applying pressure in the step of shaping the coagulum. According to the method of producing silken tofu, the solid content of the soy milk coagulum can be adjusted by adjusting the solid content of the soy milk in advance by concentration or dilution, and adding a coagulant to coagulate the entire soy milk. In addition, the solid content of the soy milk coagulum can also be adjusted by grinding regular tofu or silken tofu into a paste and adding water.

For the method of adjusting the solid content by applying pressure to the soy milk coagulum to dehydrate it, means commonly used for dehydrating tofu can be used; for example, the soy milk coagulum can be sandwiched between a pair of plates and dehydrated by applying pressure using a screw-type or press-type dehydrator. Instead of using a dehydrator, a weight may be placed on the plate.

### (2) Step 2: A Step of Mixing the Soy Milk Coagulum, a Coagulant, and a Protein Material to Obtain a Raw Material Mixture

### (2-1) Coagulant

The “coagulant” used in step 2 of the present invention can be any substance that has the action of aggregating proteins, and examples thereof include calcium chloride, magnesium chloride, calcium sulfate, magnesium sulfate, and glucono delta-lactone, and mixtures thereof may also be used. Naturally occurring bittern containing magnesium chloride as a main component, and emulsified coagulants whose surfaces are coated with oil and/or fat to enhance coagulation stability can also be used. The coagulant may be the same as or different from the coagulant used in the production of the soy milk coagulum. Since the coagulant is difficult to disperse, it can be premixed with the protein material or dissolved in water before use.

The amount of the coagulant used in step 2 is not limited, but from the viewpoint of effectively enhancing the thermal coagulation of the protein (which has thermal coagulability) derived from the protein material, it is preferably 0.3 parts by mass or more, more preferably 0.6 parts by mass or more, and even more preferably 1 part by mass or more, relative to 100 parts by mass of the protein derived from the protein material. Although there is no particular upper limit, since there is a limit to the effect even if the amount used is too large, it is preferably 12 parts by mass or less, more preferably 10 parts by mass or less, and even more preferably 8 parts by mass or less. By setting the amount within such a range, it is possible to obtain processed soy milk food having a meat-like texture with good mouthfeel and hardness. Furthermore, it is possible to obtain processed soy milk food having a good texture even after freezing and thawing.

### (2-2) Protein Material

The “protein material” used in the present invention is any protein material that contains a protein having thermal coagulability as a main component, among the protein materials applicable for food use and separated and purified from plant-based materials such as legumes and grains or animal-based materials such as eggs. Such proteins include soy protein, pea protein, chickpea protein, mung bean protein, broad bean protein, wheat protein, egg protein, and the like. The proteins having thermal coagulability contained in these separated and purified protein materials are all coagulated and gelled by heating at about 70° C. or higher; for example, in the case of soy protein, the thermal coagulation ability reaches its maximum at 80° C., and does not change even if the temperature exceeds 80° C. From the viewpoint of being a plant-based protein with a good balance of constituent amino acids, soy protein is preferable. The protein content in the protein material may be 60% by mass or more, preferably 70% by mass or more, more preferably 85% by mass or more, and even more preferably 90% by mass or more. Such a protein material may be prepared by a known method or a commercially available product may be used.

### (2-3) Step of Obtaining a Raw Material Mixture

The method of producing processed soy milk food of the present invention includes a step of mixing the soy milk coagulum, a coagulant, and a protein material to obtain a raw material mixture. The “raw material mixture” in the present invention is preferably a plastic dough-like material that can be molded without using a mold.

The means for mixing is not particularly limited, and any known mixing means can be suitably applied. It is desirable to use a mixer that can strongly knead while cutting the soy milk coagulum and can stir at high speed; for example, mixing may be performed using a cutting and mixing type mixer such as a cutter mixer or a silent cutter, or a strong kneading type mixer such as a vertical mixer.

In the present invention, the amount of solid content derived from the soy milk coagulum in the raw material mixture is 2.5% by mass or more, preferably 3% by mass or more, more preferably 5% by mass or more, and even more preferably 8% by mass or more. Although there is no particular upper limit, it is preferably 30% by mass or less, more preferably 25% by mass or less, even more preferably 20 parts by mass or less, and still more preferably 15% by mass or less from the viewpoint of industrial efficiency (equipment operating cost and operating time) related to dehydration of the soy milk coagulum. In order to adjust the amount of solid content derived from the soy milk coagulum in the raw material mixture to be within the above range, the solid content (water content) of the soy milk coagulum may be adjusted in advance in step 1; for example, the soy milk coagulum may be dehydrated so that the water content is 60% by mass or more relative to the total amount of the soy milk coagulum, or 180 parts by mass or less of water may be added to and mixed with 100 parts by mass of the paste obtained by grinding the soy milk coagulum. Alternatively, the amount of solid content derived from the soy milk coagulum may be adjusted by further adding and mixing water in step 2.

The amount of solid content derived from the soy milk coagulum can be measured by a heating and drying method, an infrared measurement method, or the like. Using an infrared moisture meter (FD-720, manufactured by Kett Electric Laboratory), the water content of the soy milk coagulum can be easily measured, and the amount of solid content can be determined by the difference.

In the present invention, the amount of the protein material used to obtain the raw material mixture is, as the amount of protein derived from the protein material, 9.5% by mass or more, preferably 10% by mass or more, and more preferably 15% by mass or more, and 34% by mass or less, preferably 30% by mass or less, and more preferably 25% by mass or less, relative to the total amount of the raw material mixture. By setting the amount within the above range, it is possible to obtain processed soy milk food having a meat-like texture with good mouthfeel and hardness. Furthermore, it is possible to obtain processed soy milk food having a good texture even after freezing and thawing. The amount of protein in the protein material can be measured by a known method such as the Kjeldahl method.

In the present invention, the raw material mixture may further contain, as optional components, oils and/or fats (such as lard, beef tallow, rapeseed oil, palm oil, soybean oil, rice oil, and corn oil), hardened oils and/or fats obtained by hydrogenating the oils and/or fats, powdered oils and/or fats obtained by powdering the oils and/or fats together with carriers and emulsifiers, and other oils and/or fats; emulsifiers (such as glycerin fatty acid esters, sucrose fatty acid esters, and lecithin); emulsified oils and/or fats containing emulsifiers; starches such as tapioca starch, wheat starch, and potato starch; modified starches obtained by chemically, physically, or enzymatically modifying starches; thickeners such as xanthan gum, guar gum, and tara gum; cellulose derivatives; spices; seasonings; pigments; flavors, and other auxiliary raw materials or additives, within a range that does not impair the effects of the present invention. In particular, the addition of oil and/or fat can provide a smoother and more elastic texture.

### (3) Step 3: A Step of Heating the Raw Material Mixture

The method of producing processed soy milk food of the present invention includes a step of heating the raw material mixture.

For heating, the obtained raw material mixture may be molded into an arbitrary shape. From the viewpoints of heating efficiency and commercial value, the shape can be a ball shape, a rod shape, a ground meat shape, a sheet shape, or the like. The shaping means is not particularly limited, but from the viewpoint of continuous production, extrusion molding is desirable; the raw material mixture may be extruded using a meat chopper, a twin-screw inline mixer, or the like, and then molded into an arbitrary shape using a die.

The means for heating the raw material mixture is not particularly limited, and any known heating means can be suitably applied. In this heating step, the thermal gelation of the protein having thermal coagulability can be promoted by the action of the coagulant used in step 2. Specific examples of the heating means include steaming treatment, boiling treatment in hot water, steam convection treatment, superheated steam treatment, and hot air jet treatment (jet oven). The heating treatment conditions depend on the size and shape of the raw material mixture, but may be any conditions as long as the temperature reaches a temperature at which the thermocoagulable protein thermally coagulates and gels. More specifically, the temperature of the core (the part where heat is most difficult to pass through) of the raw material mixture may be 70° C. or higher, preferably 75° C. or higher, and more preferably 80° C. or higher. From the viewpoint of hygiene management in food production, it is more preferable that the core temperature is 85° C. for 1 minute or more, or equivalent heating or more, so that heat sterilization treatment can be performed simultaneously. When the raw material mixture is molded into a ground meat shape with a diameter of about 4 mm, heating may be performed at 90 to 100° C. for 20 to 90 minutes in the case of steaming treatment or boiling treatment, at 110 to 300° C. for 1 to 10 minutes in the case of steam convection treatment or superheated steam treatment, or at 160 to 200° C. for 2 to 10 minutes in the case of hot air jet treatment. Such heating conditions may be appropriately adjusted depending on the type of protein material used and the size and shape of the molded raw material mixture. During heating, the raw material mixture may be sealed and packaged in a heat-resistant packaging material.

### (4) Step of Freezing the Heated Raw Material Mixture

The method of producing processed soy milk food of the present invention may include a step of freezing the heated raw material mixture.

The heat-treated raw material mixture can be used as an intermediate raw material and used as a processed meat-like food such as hamburger. That is, the present invention may further include a step of cooking the heated raw material mixture to obtain a processed meat-like food before the step of freezing the heated raw material mixture. The raw material mixture or the food processed from the raw material mixture can be frozen immediately or after cooling to a predetermined temperature (e.g., room temperature).

The method of cooling to a predetermined temperature is not particularly limited, and examples thereof include a method of directly applying cold air to the heat-treated raw material mixture, a method of vacuum cooling, a method of naturally cooling at room temperature, and a method of cooling the raw material mixture sealed in a container with running water.

The method of freezing is not particularly limited, and examples thereof include an air blast method using cold air as a medium, a liquid method using a liquid at −10 to −35° C. as a medium, a contact method using a low-temperature metal plate or the like as a medium, and a liquefied gas method using liquid nitrogen or liquid carbon dioxide as a medium. Proton freezing, which combines magnets, electromagnetic waves, and cold air, or CAS freezing, which utilizes the supercooled state of water, may also be used. It is essential to freeze rapidly under conditions that inhibit ice crystal growth in the water within the processed soy milk food. For frozen storage, a household freezer, a commercial freezer, or the like may be used.

### EXAMPLES

Hereinafter, production examples will be shown to specifically explain the present invention, but the present invention is not limited to only the following production examples.

### Production Example 1: Production of Meat-Like Food

Processed soy milk food was produced using the raw materials shown in the following formulation table. That is,
(1) A soy milk coagulum (water content: 90% by mass) was sandwiched between plates, a weight was placed on top of the plates to dehydrate the soy milk coagulum, and the water content of the soy milk coagulum was adjusted to 85% by mass. The water content of the soy milk coagulum before and after adjusting the water content was measured using an infrared moisture meter (FD-720, manufactured by Kett Electric Laboratory) according to the manual.
(2) The soy milk coagulum whose water content had been adjusted was put into a food processor (MK-K48P, manufactured by Panasonic Corporation) and mixed to obtain a soy milk coagulum paste.
(3) 100 parts by mass of the soy milk coagulum paste, 33.3 parts by mass of the protein material (30 parts by mass as protein), and 1.2 parts by mass of a 50% by mass coagulant solution (0.6 parts by mass as coagulant) were mixed in a vertical mixer (HPi-20M, manufactured by KANTO KONGOKI INDUSTRIAL Co., Ltd.) at low speed for 2 minutes and then at medium speed for 5 minutes to obtain a raw material mixture.
(4) The obtained raw material mixture was packed in a bag made of vinylidene chloride resin, and heat-sealed to be airtight.
(5) The bag was put into a steamer (combi oven iCombi Classic FCCMPXS, manufactured by Fujimak Corporation) and heated at 95° C. for 30 minutes to obtain processed soy milk food. When the temperature at the core of the raw material mixture was monitored using a temperature sensor (Wireless Logging Station LR8410, manufactured by HIOKI E.E. CORPORATION), the temperature reached 75° C. within 5 minutes after the start of heating.
(6) The mixture was cooled with running water until the residual heat was removed.
(7) The mixture was frozen using a quick freezer, and the obtained frozen processed soy milk food was stored in a freezer at −20° C.

Formulation Table

| Raw material name | Parts by mass |
|---|---|
| Soy milk coagulum | 100 |
| Protein material | 33.3 |
| 50% by mass coagulant solution | 1.2 |

The soy milk coagulum is regular tofu (Organic Soybean Momen, manufactured by Asahi Shokuhin Kogyo Co., Ltd.).

The protein material is powdered isolated soy protein (GS5100N, manufactured by Gushen Japan Co., Ltd.), and the protein content measured by the Kjeldahl method was 90% by mass.

The coagulant is magnesium chloride (Soft Wafer, manufactured by Ako Kasei Co., Ltd.).

### Evaluation Example 1

The frozen processed soy milk food was thawed by putting it in a boiling water bath. Unfrozen processed soy milk food and frozen and thawed processed soy milk food were subjected to sensory evaluation by 10 skilled panelists, and evaluated according to the following evaluation criteria table to obtain an average score.

Evaluation Criteria Table

| | | |
|---|---|---|
| Mouthfeel | 5 points | No dryness or roughness |
| | 4 points | Almost no dryness |
| | | or roughness |
| | 3 points | Normal |
| | 2 points | Slightly dry or rough |
| | 1 point | Dry or rough |
| Hardness | 5 points | Hard and elastic |
| (elasticity) | 4 points | Slightly hard and elastic |
| | 3 points | Normal |
| | 2 points | Slightly soft |
| | 1 point | Soft |

### Test Example 1: Examination of Amount and Type of Coagulant

Processed soy milk food was produced according to Production Example 1, except that a 50% by mass coagulant solution shown in Table 1 was used, and evaluated according to Evaluation Example 1. The parts by mass of the coagulant and water in the table indicate the amounts of each contained in the 50% coagulant solution. The mouthfeel and hardness of the unfrozen processed soy milk food (unfrozen product) of the reference example in which no coagulant was used were set to 3 points. The results are shown in Table 1.

In the unfrozen products, in Examples 1 to 5 in which a coagulant was used, the mouthfeel was good without dryness or roughness, and was particularly good in Examples 1 and 2. The hardness improved depending on the amount of the coagulant used, and was the same in Examples 4 and 5, reaching the upper limit of the coagulant addition effect.

In the processed soy milk foods (frozen and thawed products) of Examples 1 to 5 that were frozen and then thawed, the evaluation of mouthfeel and hardness was slightly lower than that of the unfrozen products, but the texture was superior to that of the frozen and thawed product of the reference example.

In Examples 6 to 11, when various coagulants and combinations thereof were used, the mouthfeel and hardness were improved in all cases compared to the reference example.

TABLE 1
(Addition of coagulant)

| | Reference | Example | | | | |
|---|---|---|---|---|---|---|
| (Parts by mass) | Example | 1 | 2 | 3 | 4 | 5 |
| Magnesium chloride | — | 0.1 | 0.2 | 0.6 | 2 | 3 |
| Calcium chloride | — | — | — | — | — | — |
| Calcium sulfate | — | — | — | — | — | — |
| Glucono delta-lactone | — | — | — | — | — | — |
| Solid content (parts by mass) | 46.6 | 46.7 | 46.8 | 47.2 | 48.6 | 49.6 |
| (Derived from soy milk coagulum) | (15) | (15) | (15) | (15) | (15) | (15) |
| (Derived from protein material) | (31.6) | (31.6) | (31.6) | (31.6) | (31.6) | (31.6) |
| (Derived from coagulant solution) | (0) | (0.1) | (0.2) | (0.6) | (2) | (3) |
| Water content (parts by mass) | 86.7 | 86.8 | 86.9 | 87.3 | 88.7 | 89.7 |
| (Derived from soy milk coagulum) | (85) | (85) | (85) | (85) | (85) | (85) |
| (Derived from protein material) | (1.7) | (1.7) | (1.7) | (1.7) | (1.7) | (1.7) |
| (Derived from coagulant solution) | (0) | (0.1) | (0.2) | (0.6) | (2) | (3) |
| Protein amount (derived from protein | 30 | 30 | 30 | 30 | 30 | 30 |
| material) (parts by mass) | | | | | | |

Content in total amount of raw material mixture (% by mass)

| Protein derived from protein material | | 22.5 | 22.5 | 22.4 | 22.3 | 21.8 | 21.5 |
|---|---|---|---|---|---|---|---|
| Solid content derived from soy milk | | 11.3 | 11.2 | 11.2 | 11.1 | 10.9 | 10.8 |
| coagulum | | | | | | | |
| Water | | 65.0 | 65.0 | 65.0 | 64.9 | 64.6 | 64.4 |
| Coagulant amount/protein amount derived | | — | 0.0033 | 0.0067 | 0.02 | 0.0667 | 0.1 |
| from protein material | | | | | | | |
| Unfrozen product | Mouthfeel | 3.0 | 3.6 | 3.6 | 3.5 | 3.3 | 3.2 |
| | Hardness | 3.0 | 3.1 | 3.5 | 4.0 | 4.2 | 4.2 |
| Frozen and | Mouthfeel | 2.5 | 3.1 | 3.2 | 3.2 | 3.2 | 3.0 |
| thawed product | Hardness | 2.2 | 2.6 | 3.0 | 3.7 | 4.0 | 4.0 |

| | Example | | | | | |
|---|---|---|---|---|---|---|
| (Parts by mass) | 6 | 7 | 8 | 9 | 10 | 11 |
| Magnesium chloride | — | — | — | 0.6 | — | — |
| Calcium chloride | 0.6 | — | — | 0.2 | — | — |
| Calcium sulfate | — | 0.6 | — | — | 0.6 | 0.1 |
| Glucono delta-lactone | — | — | 0.6 | — | 0.3 | 0.5 |
| Solid content (parts by mass) | 47.2 | 47.2 | 47.2 | 47.4 | 47.5 | 47.2 |
| (Derived from soy milk coagulum) | (15) | (15) | (15) | (15) | (15) | (15) |
| (Derived from protein material) | (31.6) | (31.6) | (31.6) | (31.6) | (31.6) | (31.6) |
| (Derived from coagulant solution) | (0.6) | (0.6) | (0.6) | (0.8) | (0.9) | (0.6) |
| Water content (parts by mass) | 87.3 | 87.3 | 87.3 | 87.5 | 87.6 | 87.3 |
| (Derived from soy milk coagulum) | (85) | (85) | (85) | (85) | (85) | (85) |
| (Derived from protein material) | (1.7) | (1.7) | (1.7) | (1.7) | (1.7) | (1.7) |
| (Derived from coagulant solution) | (0.6) | (0.6) | (0.6) | (0.8) | (0.9) | (0.6) |
| Protein amount (derived from protein | 30 | 30 | 30 | 30 | 30 | 30 |
| material) (parts by mass) | | | | | | |

Content in total amount of raw material mixture (% by mass)

| Protein derived from protein material | | 22.3 | 22.3 | 22.3 | 22.2 | 22.2 | 22.3 |
|---|---|---|---|---|---|---|---|
| Solid content derived from soy milk | | 11.2 | 11.2 | 11.2 | 11.1 | 11.1 | 11.2 |
| coagulum | | | | | | | |
| Water | | 64.9 | 64.9 | 64.9 | 64.9 | 64.9 | 64.9 |
| Coagulant amount/protein amount derived | | 0.02 | 0.02 | 0.02 | 0.027 | 0.03 | 0.02 |
| from protein material | | | | | | | |
| Unfrozen product | Mouthfeel | 3.4 | 3.6 | 3.6 | 3.4 | 3.6 | 3.6 |
| | Hardness | 4.0 | 3.9 | 3.9 | 4.1 | 3.9 | 3.9 |
| Frozen and thawed | Mouthfeel | 3.1 | 3.4 | 3.3 | 3.1 | 3.4 | 3.3 |
| product | Hardness | 3.7 | 3.6 | 3.6 | 3.8 | 3.6 | 3.6 |

Magnesium chloride: “Soft Wafer” manufactured by Ako Kasei Co., Ltd.
Calcium chloride: “Granular Calcium Chloride” manufactured by Tokuyama Corporation
Calcium sulfate: “Pearl” manufactured by Ako Kasei Co., Ltd.
Glucono delta-lactone: “Fujiglucon” manufactured by Fuso Chemical Co., Ltd.

### Test Example 2: Examination of Solid Content Derived from Soy Milk Coagulum

The water content of the raw material mixture was adjusted to the water content shown in Table 2, and the amount of solid content derived from the soy milk coagulum contained in the raw material mixture was examined. The processed soy milk food was produced according to Production Example 1, except for the adjustment of the water content of the raw material mixture, and evaluated according to Evaluation Example 1. The results are shown in Table 2. In Examples 12, 13, and 3, the water content was adjusted by dehydrating the soy milk coagulum (regular tofu) in step (1) of Production Example 1, and in Example 15 and Comparative Example 1, the soy milk coagulum was not dehydrated in step (1) of Production Example 1, and the raw material mixture was obtained by adding water in step (3) of Production Example 1.

All of Examples 12 to 15 had good mouthfeel and hardness compared to the reference example. Regarding mouthfeel, the mouthfeel became better as the solid content ratio derived from the soy milk coagulum decreased, and the hardness became better as the solid content ratio derived from the soy milk coagulum increased. In Example 12 after freezing and thawing, the mouthfeel was slightly unsatisfactory compared to the other examples, but the evaluation score was better than that of the reference example. In Example 15 after freezing and thawing, the hardness was slightly unsatisfactory compared to the other examples, but the evaluation score was higher than that of the reference example. In Comparative Example 1, in which the solid content ratio derived from the soy milk coagulum was further reduced, the evaluation of the hardness of the unfrozen product was lower than that of Reference Example 1, and the hardness of the frozen and thawed product was also insufficient.

TABLE 2
(Difference in solid content derived from soy milk coagulum)

| | | | | | | Comparative |
|---|---|---|---|---|---|---|
| | Example | | | | | Example |
| | 12 | 13 | 3 | 14 | 15 | 1 |
| Water content of soy milk coagulum | 65 | 70 | 85 | 90 | 90 | 90 |
| (% by mass) | | | | | | |
| Soy milk coagulum (parts by mass) | 100 | 100 | 100 | 100 | 50 | 20 |
| Water addition (parts by mass) | 0 | 0 | 0 | 0 | 50 | 80 |
| Solid content (parts by mass) | 67.2 | 62.2 | 47.2 | 42.2 | 37.2 | 34.2 |
| (Derived from soy milk coagulum) | (35) | (30) | (15) | (10) | (5) | (2) |
| (Derived from protein material) | (31.6) | (31.6) | (31.6) | (31.6) | (31.6) | (31.6) |
| (Derived from coagulant solution) | (0.6) | (0.6) | (0.6) | (0.6) | (0.6) | (0.6) |
| Water content (parts by mass) | 67.3 | 72.3 | 87.3 | 92.3 | 97.3 | 100.3 |
| (Derived from soy milk coagulum) | (65) | (70) | (85) | (90) | (45) | (18) |
| (Derived from protein material) | (1.7) | (1.7) | (1.7) | (1.7) | (1.7) | (1.7) |
| (Derived from coagulant solution) | (0.6) | (0.6) | (0.6) | (0.6) | (0.6) | (0.6) |
| (Derived from water addition) | (0) | (0) | (0) | (0) | (50) | (80) |
| Protein amount (derived from protein | 30 | 30 | 30 | 30 | 30 | 30 |
| material) (parts by mass) | | | | | | |

Content in total amount of raw material mixture (% by mass)

| Protein derived from protein material | | 22.3 | 22.3 | 22.3 | 22.3 | 22.3 | 22.3 |
|---|---|---|---|---|---|---|---|
| Solid content derived from soy milk | | 26.0 | 22.3 | 11.2 | 7.4 | 3.7 | 1.5 |
| coagulum | | | | | | | |
| Water | | 50.0 | 53.8 | 64.9 | 68.6 | 72.3 | 74.6 |
| Coagulant amount/protein amount derived | | 0.02 | 0.02 | 0.02 | 0.02 | 0.02 | 0.02 |
| from protein material | | | | | | | |
| Unfrozen product | Mouthfeel | 3.3 | 3.4 | 3.5 | 3.7 | 3.7 | 3.7 |
| | Hardness | 4.2 | 4.1 | 4.0 | 3.8 | 3.6 | 2.8 |
| Frozen and thawed product | Mouthfeel | 2.8 | 3.0 | 3.2 | 3.4 | 3.4 | 3.3 |
| | Hardness | 3.4 | 3.8 | 3.7 | 3.3 | 2.8 | 2.4 |

### Test Example 3: Examination of Amount of Protein

Processed soy milk food was produced according to Production Example 1, except that the amount of protein derived from the protein material was as shown in Table 3, and evaluated according to Evaluation Example 1.

Comparative Example 2, in which the amount of protein derived from the protein material was 8.9% by mass relative to the total amount of the raw material mixture, had the best mouthfeel, but the evaluation of the hardness of the unfrozen product was lower than that of the reference example. The evaluation score of hardness increased with increasing amount of protein derived from the protein material, and in Examples 16, 3, and 17, the mouthfeel and hardness were both evaluated higher than the reference example in the sensory evaluation of the unfrozen product and the frozen and thawed product. Comparative Example 3, in which the amount of protein derived from the protein material was 35.8% by mass relative to the total amount of the raw material mixture, had the best hardness, but the evaluation of the mouthfeel of the unfrozen product was lower than that of the reference example, and the evaluation of the frozen and thawed product was the same as that of the reference example.

TABLE 3
(Difference in amount of added protein)

| | Comparative | | | | Comparative |
|---|---|---|---|---|---|
| | Example | Example | | | Example |
| | 2 | 16 | 3 | 17 | 3 |
| Solid content (parts by mass) | 26.1 | 28.2 | 47.2 | 63.1 | 78.7 |
| (Derived from soy milk coagulum) | (15) | (15) | (15) | (15) | (15) |
| (Derived from protein material) | (10.5) | (12.6) | (31.6) | (47.5) | (63.1) |
| (Derived from coagulant solution) | (0.6) | (0.6) | (0.6) | (0.6) | (0.6) |
| Water content (parts by mass) | 86.2 | 86.3 | 87.3 | 88.1 | 89.1 |
| (Derived from soy milk coagulum) | (85) | (85) | (85) | (85) | (85) |
| (Derived from protein material) | (0.6) | (0.7) | (1.7) | (2.5) | (3.5) |
| (Derived from coagulant solution) | (0.6) | (0.6) | (0.6) | (0.6) | (0.6) |
| Protein amount (derived from protein | 10 | 12 | 30 | 45 | 60 |
| material) (parts by mass) | | | | | |

Content in total amount of raw material mixture (% by mass)

| Protein derived from protein material | | 8.9 | 10.5 | 22.3 | 29.7 | 35.8 |
|---|---|---|---|---|---|---|
| Solid content derived from soy milk | | 13.4 | 13.1 | 11.2 | 9.6 | 8.9 |
| coagulum | | | | | | |
| Water | | 76.8 | 75.4 | 64.9 | 58.3 | 53.1 |
| Coagulant amount/protein amount derived | | 0.06 | 0.05 | 0.02 | 0.012 | 0.01 |
| from protein material | | | | | | |
| Unfrozen product | Mouthfeel | 3.7 | 3.7 | 3.5 | 3.3 | 2.7 |
| | Hardness | 2.8 | 3.3 | 4.0 | 4.3 | 4.5 |
| Frozen and thawed product | Mouthfeel | 3.4 | 3.4 | 3.2 | 3.0 | 2.5 |
| | Hardness | 2.5 | 3.0 | 3.7 | 4.0 | 4.2 |

*Parts by mass relative to 100 parts by mass of soy milk coagulum paste; for protein material, the amount of protein is shown.
Soy protein isolate: “GS5100N” manufactured by Gushen Japan Co., Ltd., protein measurement value: 90% by mass

### Test Example 4: Examination of Type of Protein

Processed soy milk food was produced according to Production Example 1, except that the types of protein materials shown in Table 4 were used, and evaluated according to Evaluation Example 1. The protein content of each protein material was measured by the Kjeldahl method.

Regardless of the type of protein material added, the mouthfeel and hardness were good in both the unfrozen product and the frozen and thawed product.

TABLE 4
(Change of protein material)

| | | Example | | | | | | |
|---|---|---|---|---|---|---|---|---|
| | | 3 | 18 | 19 | 20 | 21 | 22 | 23 |
| Solid content (parts by mass) | | 47.2 | 49.0 | 59.9 | 52.8 | 49.2 | 50.0 | 48.1 |
| (Derived from soy milk coagulum) | | (15) | (15) | (15) | (15) | (15) | (15) | (15) |
| (Derived from protein material) | | (31.6) | (33.4) | (44.3) | (37.2) | (33.6) | (34.4) | (32.5) |
| (Derived from coagulant solution) | | (0.6) | (0.6) | (0.6) | (0.6) | (0.6) | (0.6) | (0.6) |
| Water content (parts by mass) | | 87.3 | 88.3 | 88.9 | 88.4 | 87.7 | 87.8 | 88.0 |
| (Derived from soy milk coagulum) | | (85) | (85) | (85) | (85) | (85) | (85) | (85) |
| (Derived from protein material) | | (1.7) | (2.7) | (3.3) | (2.8) | (2.1) | (2.2) | (2.4) |
| (Derived from coagulant solution) | | (0.6) | (0.6) | (0.6) | (0.6) | (0.6) | (0.6) | (0.6) |
| Protein amount | Soy protein | 30 | | | | | | |
| (derived from | Pea protein | | 30 | | | | | |
| protein material) | Chickpea protein | | | 30 | | | | |
| (parts by mass) | Mung bean protein | | | | 30 | | | |
| | Broad bean protein | | | | | 30 | | |
| | Wheat protein | | | | | | 30 | |
| | Egg protein | | | | | | | 30 |

Content in total amount of raw material mixture (% by mass)

| Protein derived from protein material | | 22.3 | 21.8 | 20.2 | 21.2 | 21.9 | 21.8 | 22.0 |
|---|---|---|---|---|---|---|---|---|
| Solid content derived from soy milk | | 11.2 | 10.9 | 10.1 | 10.6 | 11.0 | 10.9 | 11.0 |
| coagulum | | | | | | | | |
| Water | | 64.9 | 64.3 | 59.7 | 62.6 | 64.1 | 63.7 | 64.7 |
| Coagulant amount/protein amount derived | | 0.02 | 0.02 | 0.02 | 0.02 | 0.02 | 0.02 | 0.02 |
| from protein material | | | | | | | | |
| Unfrozen product | Mouthfeel | 3.5 | 3.5 | 3.6 | 3.5 | 3.5 | 3.5 | 3.4 |
| | Hardness | 4.0 | 3.7 | 3.5 | 3.7 | 3.6 | 3.7 | 4.4 |
| Frozen and thawed | Mouthfeel | 3.2 | 3.3 | 3.4 | 3.3 | 3.4 | 3.3 | 3.1 |
| product | Hardness | 3.7 | 3.4 | 3.2 | 3.4 | 3.3 | 3.5 | 4.0 |

*Parts by mass relative to 100 parts by mass of soy milk coagulum paste; for protein material, the amount of protein is shown.
Soy protein: “GS5100N” manufactured by Gushen Japan Co., Ltd., protein content: 90% by mass
Pea protein: “TRUPRO 2000” manufactured by International Flavors & Fragrances Ltd., protein measurement value: 83% by mass
Chickpea protein: “ORPROTEIN CP-AC” manufactured by Organo Foodtech Co., Ltd., protein measurement value: 64% by mass
Mung bean protein: “ORPROTEIN MP-AC” manufactured by Organo Foodtech Co., Ltd., protein measurement value: 75% by mass
Broad bean protein: “ORPROTEIN FP-AC” manufactured by Organo Foodtech Co., Ltd., protein measurement value: 84% by mass
Wheat protein: “A-Glu WP” manufactured by Glico Nutrition Co., Ltd., protein measurement value: 82% by mass
Egg protein: “Egg White Powder” manufactured by Kewpie Egg Corporation, protein measurement value: 86% by mass

1. A method of producing processed soy milk food, comprising the following steps 1 to 3 and satisfying conditions 1 and 2
step 1: a step of preparing a soy milk coagulum,
step 2: a step of mixing the soy milk coagulum, a coagulant, and a protein material to obtain a raw material mixture, where
condition 1: the amount of protein derived from the protein material is 9.5 to 34% by mass relative to the total amount of the raw material mixture, and
condition 2: the amount of solid content derived from the soy milk coagulum is 2.5 to 30% by mass relative to the total amount of the raw material mixture, and
step 3: a step of heating the raw material mixture.

2. The method of producing processed soy milk food according to claim 1, wherein the amount of the coagulant used in step 2 is 0.3 to 10 parts by mass relative to 100 parts by mass of the protein derived from the protein material.

3. The method of producing processed soy milk food according to claim 1, wherein the protein material is selected from the group consisting of soy protein isolate, pea protein, chickpea protein, mung bean protein, broad bean protein, wheat protein, and egg protein.

4. The method of producing processed soy milk food according to claim 1, further comprising a step of freezing the heated raw material mixture after step 3.
